(19) United States
(12) Patent Application Publication
(10) Pub. No.: US 2026/0074241 A1
(43) Pub. Date: Mar. 12, 2026

(54) FUEL CELL

(71) Applicant: TOYOTA JIDOSHA KABUSHIKI KAISHA, Toyota-shi (JP)

(72) Inventors: Yuto TAMURA, Miyoshi-shi (JP); Hiroya NAKAJI, Toyota-shi (JP); Takuya KURIHARA, Miyoshi-shi (JP)

(73) Assignee: TOYOTA JIDOSHA KABUSHIKI KAISHA, Toyota-shi (JP)

(21) Appl. No.: 19/233,444

(22) Filed: Jun. 10, 2025

(30) Foreign Application Priority Data
Sep. 6, 2024 (JP) 2024-153884

(51) Int. Cl. H01M 8/0247; H01M 8/0271

(52) U.S. Cl. CPC H01M 8/0247; H01M 8/0271

(57) ABSTRACT

A fuel cell including an electrode assembly between a pair of separators includes a gasket disposed on a surface of one of the separators on a side opposite to a surface on a side on which the electrode assembly is disposed, and a protruding member disposed on a surface of one of the separators on a side opposite to a surface on a side on which the electrode assembly is disposed. The protruding member is disposed on an outer peripheral edge side of the separator from the gasket. The height of the protruding member is smaller than the height of the gasket.

### CROSS-REFERENCE TO RELATED APPLICATION

This application claims priority to Japanese Patent Application No. 2024-153884 filed on Sep. 6, 2024. The disclosure of the above-identified application, including the specification, drawings, and claims, is incorporated by reference herein in its entirety.

### BACKGROUND

### 1. Technical Field

The present disclosure relates to a fuel cell.

### 2. Description of Related Art

Japanese Unexamined Patent Application Publication No. 2018-181604 (JP 2018-181604 A) discloses the following configuration. That is, a fuel cell including two separators and a frame member and a membrane electrode assembly disposed between the two separators is provided, and a gasket that prevents leakage of reactive gas is provided between a first fuel cell and a second fuel cell.

Japanese Unexamined Patent Application Publication No. 2011-129267 (JP 2011-129267 A) discloses a short-circuit prevention structure for a fuel cell in which, on one of separators, a gasket and an insulator are provided, and the insulator is provided in a region of a gasket peripheral edge portion.

### SUMMARY

When the fuel cell is formed by joining the two separators and the frame member and the membrane electrode assembly disposed between the two separators by hot pressing, the fuel cell is brought to a warped state. Accordingly, when a fuel cell unit (sometimes also called a fuel cell stack) is formed by stacking a plurality of fuel cells, a compression amount of the gasket disposed as a sealing member between adjacent fuel cells is reduced, and there is a possibility of causing gas leakage. The pitch of the fuel cells particularly increases from one end side (a side on which the compression force is applied) to the other end side in the stacking direction of the fuel cells. As a result, the compression amount of the gasket is reduced on the other end side, and thus gas leakage is likely to be caused.

In view of the above-mentioned problem, the present disclosure has an object to provide a fuel cell capable of preventing occurrence of gas leakage.

The present application discloses a fuel cell including an electrode assembly between a pair of separators. The fuel cell further includes a gasket disposed on a surface of one of the separators on a side opposite to a surface on a side on which the electrode assembly is disposed, and a protruding member disposed on a surface of one of the separators on a side opposite to a surface on a side on which the electrode assembly is disposed. The protruding member is disposed on an outer peripheral edge side of the separator from the gasket. The height of the protruding member is smaller than the height of the gasket.

The protruding member may be disposed on the same surface as the surface of the one of the separators on which the gasket is disposed.

The protruding member may be disposed on the surface of the one of the separators on the side opposite to the surface on which the gasket is disposed.

The protruding member may be the same material as the gasket.

With the present disclosure, the amount of reduction in gasket compression amount is reduced by the protruding member, and hence gas leakage can be prevented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a fuel cell 10;

FIG. 2 is a plan view of the fuel cell 10;

FIG. 3 is an explanatory conceptual diagram illustrating a layer configuration in a power generation portion 11 of the fuel cell 10;

FIG. 4 is an explanatory conceptual diagram illustrating a layer configuration in an outer peripheral portion 21 of the fuel cell 10;

FIG. 5 is another embodiment example relating to arrangement of protruding members 46;

FIG. 6 is another embodiment example relating to the arrangement of the protruding members 46; and

FIG. 7 is an explanatory conceptual diagram illustrating a structure of a fuel cell stack 50.

### DETAILED DESCRIPTION OF EMBODIMENTS

### 1. Fuel Cell

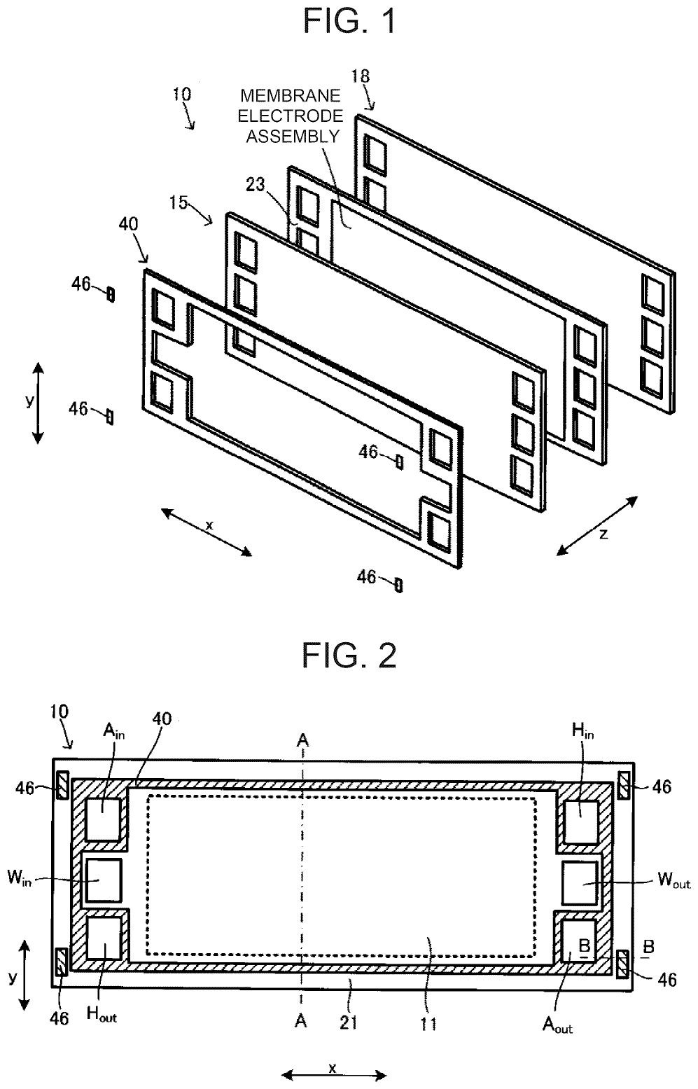

FIG. 1 to FIG. 4 are explanatory views illustrating a fuel cell 10 according to one embodiment. The fuel cell 10 is a unit element for generating electric power by being supplied with hydrogen and oxygen (air), and a fuel cell unit is configured by stacking a plurality of such fuel cells 10.

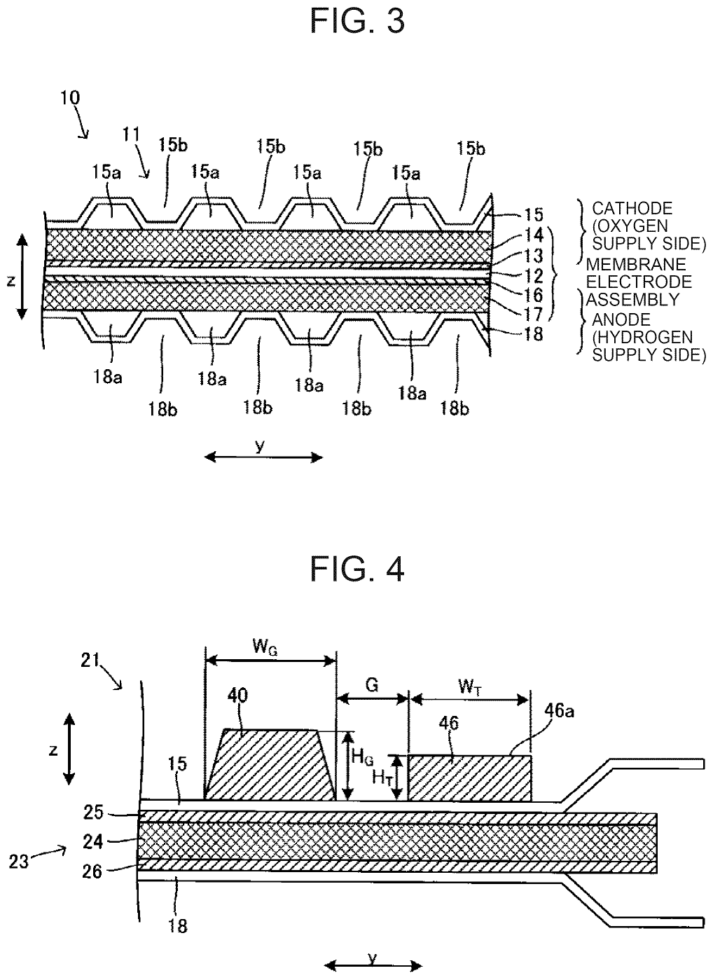

FIG. 1 is an exploded perspective view of the fuel cell 10, and FIG. 2 is a plan view of the fuel cell 10. Further, FIG. 3 is an explanatory view illustrating a layer configuration in a power generation portion 11 in the fuel cell 10, and FIG. 4 is an explanatory view illustrating a layer configuration in an outer peripheral portion 21 (a part in which a protruding member 46 is disposed) in the fuel cell 10.

In each drawing, each direction of a three-dimensional orthogonal coordinate system is indicated by an arrow. In this case, in an in-plane direction of a fuel cell having a flat plate shape as a whole, an x direction is a direction directed from an inlet side to an outlet side of a fluid, and a y direction is a direction orthogonal to the x direction. A z direction is a stacking direction of members of the fuel cell having a stacking structure.

### 1.1. Power Generation Portion

The power generation portion 11 is, for example, a part contributing to power generation in a part surrounded by the dotted line in FIG. 2, and includes a plurality of layers stacked as in FIG. 3 representing a layer configuration (a part of an A-A cross section) in the power generation portion 11.

In the power generation portion 11 of the fuel cell 10, across an electrolyte membrane 12, one side is a cathode (an oxygen supply side), and the other side is an anode (a hydrogen supply side). The cathode includes, from the electrolyte membrane 12 side, a cathode catalyst layer 13, a cathode diffusion layer 14, and a cathode separator 15 that are stacked in the stated order. Meanwhile, the anode includes, from the electrolyte membrane 12 side, an anode catalyst layer 16, an anode diffusion layer 17, and an anode separator 18 that are stacked in the stated order. It is to be noted that a stack including the electrolyte membrane 12, the cathode catalyst layer 13, the cathode diffusion layer 14, the anode catalyst layer 16, and the anode diffusion layer 17 is sometimes called a membrane electrode assembly. The thickness of the membrane electrode assembly is typically about 0.4 mm, and the thickness of the fuel cell 10 in the power generation portion 11 is typically about 1.3 mm. The cathode separator 15 and the anode separator 18 configure a pair of separators, and the membrane electrode assembly is disposed between the separators.

Each of the layers can be configured as publicly known, but is as follows, for example.

1.1a. Electrolyte Membrane

The electrolyte membrane 12 is a solid polymer thin membrane that exhibits satisfactory proton conductivity in wet conditions. The electrolyte membrane 12 is configured of, for example, a fluorine ion exchange membrane. For example, a carbon-fluorine polymer can be used. Specifically, a perfluoroalkyl sulfonic acid polymer (Nafion (registered trademark)) or the like can be given.

The thickness of the electrolyte membrane 12 is not particularly limited, and is 100 μm or less, preferably 50 μm or less, more preferably 10 μm or less.

1.1b. Cathode Catalyst Layer

The cathode catalyst layer 13 is a layer containing a catalyst metal in a form in which the catalyst metal is supported on a carrier. Examples of the catalyst metal include Pt, Pd, Rh, or alloys containing those elements. Examples of the carrier include carbon carriers, more specifically, carbon particles of glassy carbon, carbon black, activated carbon, coke, natural graphite, and artificial graphite.

1.1c. Anode Catalyst Layer

Similarly to the cathode catalyst layer 13, the anode catalyst layer 16 is also a layer containing a catalyst metal in a form in which the catalyst metal is supported on a carrier. Examples of the catalyst metal include Pt, Pd, Rh, and alloys containing those elements. Examples of the carrier include carbon carriers, more specifically, carbon particles of glassy carbon, carbon black, activated carbon, coke, natural graphite, and artificial graphite.

1.1d. Cathode Diffusion Layer

The cathode diffusion layer 14 can be configured of, for example, a porous material having electrical conductivity. More specific examples of the material include carbon porous materials (such as carbon paper, carbon cloth, and glassy carbon) and metal porous materials (metal mesh and metal foam).

The cathode diffusion layer may be provided with a microporous layer (MPL) as required. The MPL is a thin film in the form of a coating applied to the cathode catalyst layer 13 side of the cathode diffusion layer 14. The MPL is water repellent or hydrophilic as required, and has a function to adjust moisture. The MPL typically has a water-repellent resin such as polytetrafluoroethylene (PTFE) and an electrically conductive material such as carbon black as main components.

1.1e. Anode Diffusion Layer

The anode diffusion layer 17 can be configured of, for example, a porous material having electrical conductivity. More specific examples of the material include carbon porous materials (such as carbon paper, carbon cloth, and glassy carbon) and metal porous materials (metal mesh and metal foam).

1.1f. Cathode Separator

The cathode separator 15 is a member that configures the separators forming a pair together with the anode separator 18, and supplies reactive gas (air in the present embodiment) to the cathode diffusion layer 14. The cathode separator 15 has a plurality of grooves 15a on its surface facing the cathode diffusion layer 14, and those grooves function as reactive gas channels. The shape of the groove is not particularly limited as long as the reactive gas can be appropriately supplied to the cathode diffusion layer 14. As in the present embodiment, the grooves may have a shape obtained by forming corrugations in a plate-shaped member. At this time, the plate thickness is typically 0.1 mm to 0.2 mm, and the height of the corrugations is typically about 0.5 mm.

When the grooves 15a are corrugations, a groove 15b is formed between the adjacent grooves 15a on an opposite side across the cathode separator 15, and this functions as a coolant channel.

Further, in the cathode separator 15, as can be seen from FIG. 1, at positions outside of the power generation portion 11 in a portion extended from the power generation portion 11, an air inlet Aᵢₙ, a coolant inlet Wᵢₙ, and a hydrogen outlet Hₒᵤₜ are provided in parts on one end side of the grooves 15a and the grooves 15b, and an air outlet Aₒᵤₜ, a coolant outlet Wₒᵤₜ, and a hydrogen inlet Hᵢₙ are provided in parts on the other end side of the grooves 15a and the grooves 15b. In this case, the grooves 15a communicate with the air inlet Aᵢₙ and the air outlet Aₒᵤₜ and the grooves 15b communicate with the coolant inlet Wᵢₙ and the coolant outlet Wₒᵤₜ.

The material for configuring the cathode separator 15 may be any material that can be used as a separator of a fuel cell, and may be a gas-impermeable, electrically conductive material. Examples of such a material include gas-impermeable dense carbon produced by compressing carbon, and press-formed metal plates.

1.1g. Anode Separator

The anode separator 18 is a member that configures the separators forming a pair together with the cathode separator 15, and supplies reactive gas (hydrogen) to the anode diffusion layer 17. The anode separator 18 has a plurality of grooves 18a on its surface facing the anode diffusion layer 17, and those grooves function as reactive gas channels. The shape of the groove is not particularly limited as long as the reactive gas can be appropriately supplied to the anode diffusion layer 17. As in the present embodiment, the grooves may have a shape obtained by forming corrugations in a plate-shaped member. At this time, the plate thickness is typically 0.1 mm to 0.2 mm, and the height of the corrugations is typically about 0.4 mm.

When the grooves 18a are corrugations, in the present embodiment, a groove 18b is formed between the adjacent grooves 18a on an opposite side across the anode separator 18, and this functions as a coolant channel.

Further, in the anode separator 18, as can be seen from FIG. 1, at positions outside of the power generation portion 11 in a portion extended from the power generation portion 11, an air inlet Aᵢₙ, a coolant inlet Wᵢₙ, and a hydrogen outlet Hₒᵤₜ are provided in parts on one end side of the grooves 18a and the grooves 18b, and an air outlet Aₒᵤₜ, a coolant outlet Wₒᵤₜ, and a hydrogen inlet Hᵢₙ are provided in parts on the other end side of the grooves 18a and the grooves 18b. In this case, the grooves 18a communicate with the hydrogen inlet Hᵢₙ and the hydrogen outlet Hₒᵤₜ and the grooves 18b communicate with the coolant inlet Wᵢₙ and the coolant outlet Wₒᵤₜ.

The material for configuring the anode separator 18 may be any material that can be used as a separator of a fuel cell, and may be a gas-impermeable, electrically conductive material. Examples of such a material include gas-impermeable dense carbon produced by compressing carbon, and press-formed metal plates.

1.1h. Power Generation by Power Generation Portion

As publicly known, the fuel cell 10 described above generates electrical power as follows.

When hydrogen is supplied from the grooves 18a of the anode separator 18, the hydrogen passes through the anode diffusion layer 17 to be decomposed into proton (H⁺) and an electron (e⁻) in the anode catalyst layer 16. The proton passes through the electrolyte membrane 12, and the electron passes through an electrically conductive wire connected to the outside. Each of the proton and the electron reaches the cathode catalyst layer 13. Here, oxygen (air) is supplied to the cathode catalyst layer 13 from the grooves 15a of the cathode separator 15 via the cathode diffusion layer 14, and, in the cathode catalyst layer 13, water (H₂O) is generated by the proton, the electron, and the oxygen. The generated water passes through the cathode diffusion layer 14 to reach the grooves 15a of the cathode separator 15 so as to be discharged.

That is, in the fuel cell 10, a flow of electrons passing through the electrically conductive wire connected to the outside from the anode catalyst layer 16 is used as current.

### 1.2. Outer Peripheral Portion

The outer peripheral portion 21 is an outer peripheral portion of the fuel cell 10 outside of the power generation portion 11 surrounded by the dotted line in FIG. 2, and is a portion that does not contribute to power generation but supplies various fluids to the power generation portion, collects fluids from the power generation portion, and performs sealing. The outer peripheral portion 21 includes a plurality of stacked layers as illustrated in FIG. 4 representing a layer configuration (a B-B cross section) in the outer peripheral portion 21. Specifically, in the present embodiment, the outer peripheral portion 21 includes the following configuration.

1.2a. Resin Sheet

In the outer peripheral portion 21, a resin sheet 23 is disposed between the cathode separator 15 and the anode separator 18 that are the separators forming a pair, and the resin sheet 23 seals the inside of the fuel cell 10. As can be seen from FIG. 1, the resin sheet 23 is disposed so as to surround the membrane electrode assembly.

The resin sheet 23 functions as a seal member that encapsulates and seals a space between the cathode separator 15 and the anode separator 18 in the outer peripheral portion 21 of the fuel cell 10.

The resin sheet 23 includes a base material 24, an adhesive layer 25 disposed on a surface of the base material 24 on one side (a surface on the cathode separator side), and an adhesive layer 26 disposed on a surface of the base material 24 on the other side (a surface on the anode separator side). The adhesive layer 25 adheres to the cathode separator 15 and the adhesive layer 26 adheres to the anode separator 18 such that the inside of the power generation portion 11 is encapsulated and sealed.

The base material 24 has electrical insulation and airtightness, and is formed from a thermoplastic resin material having a relatively high melting point. Examples of such a material include polyethylene naphthalate, polyphenylene ether, and polyphenylene sulfide. The thickness of the base material 24 is not particularly limited, and is 0.05 mm or more and 0.25 mm or less.

The adhesive layer 25 and the adhesive layer 26 are each configured of an adhesive or a pressure-sensitive adhesive.

1.2b. Gasket

In the outer peripheral portion 21, a gasket 40 is disposed on one of the separators (in the present embodiment, the cathode separator 15) of the fuel cell 10. The gasket 40 is disposed on a surface of the separator on a side opposite to a side on which the membrane electrode assembly and the resin sheet are disposed (that is, a surface facing the stacked adjacent fuel cell 10), and functions as a seal member between adjacent fuel cells 10 when the fuel cells 10 are stacked.

A sectional shape of the gasket 40 is not particularly limited as long as the member can be used as the gasket, and examples of the sectional shape include a trapezoidal cross section as in the present embodiment. In this case, the long bottom base is on the separator side. Examples of other sectional shapes include a rectangular shape, a triangular shape, a semicircular shape, and a semielliptical shape.

Accordingly, the gasket 40 is a frame-shaped sheet member disposed along the outer peripheral portion 21 as illustrated in FIG. 1 and FIG. 2 (which is indicated by hatchings in FIG. 2). The gasket 40 preferably has sealability and also flexibility, and is thus preferably configured of an elastic member. The specific material of the elastic member is not particularly limited, and examples thereof include ethylene propylene rubber, fluorine rubber, and silicon-based rubber.

1.2c. Protruding Member

In the outer peripheral portion 21, a protruding member 46 is disposed on one or both of the separators of the fuel cell 10 (in the present embodiment, only on the cathode separator 15, on the same surface as the gasket 40). The protruding member 46 is disposed on the surface of the separator on the side opposite to the side on which the membrane electrode assembly and the resin sheet are disposed (that is, the surface facing the stacked adjacent fuel cell 10). In the part in which the protruding member 46 is disposed, the amount of reduction in gasket compression amount is reduced relative to the warping force of the fuel cell 10, and thus the gas leakage is prevented.

The protruding member 46 is disposed on a side (an outer side) closer to the edge of the separator from the gasket 40. The distance between the gasket 40 and the protruding member 46 is not particularly limited. The interval between the gasket 40 and the protruding member 46 indicated by G in FIG. 4 is preferably larger than 0 and equal to or smaller than the width of the gasket indicated by W_{G} in FIG. 4.

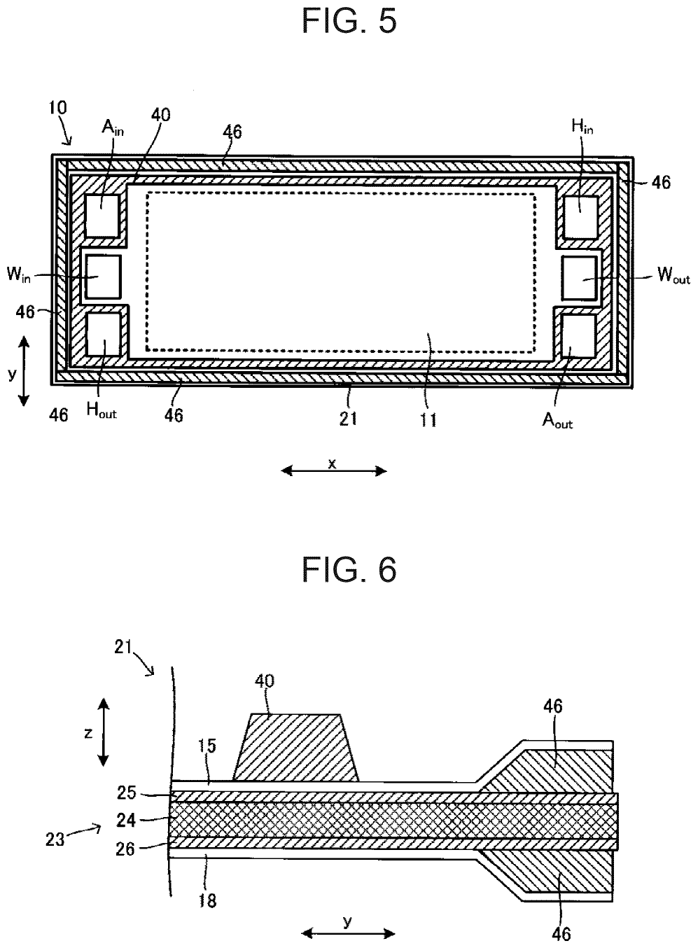

Further, as illustrated in FIG. 2, the protruding member 46 is preferably disposed at least at four corners of the separator in plan view. The warpage of the fuel cell 10 caused when the fuel cell 10 is produced is large at the four corners, and hence the effect of disposing the protruding member 46 can be further enhanced. However, from the viewpoint that the position is only required to include the four corners, the protruding member 46 may be disposed annularly along an outer peripheral edge of the fuel cell 10 as in FIG. 5.

Further, as illustrated in FIG. 6, the protruding member 46 may be disposed on a surface of the separator on a side opposite to the gasket 40 (on a side of a surface facing the resin sheet 23) under a condition in which the protruding member 46 is on an edge side (outer side) of the separator from the gasket 40 as described above. In the present embodiment, the protruding member 46 is disposed at an end portion having an increased interval between the separators. Here, the protruding member 46 is disposed between the resin sheet 23 and the cathode separator 15, and between the resin sheet 23 and the anode separator 18.

The height of the protruding member 46 indicated by HT in FIG. 4 is smaller than the height of the gasket 40 indicated by HG in FIG. 4. The difference of the heights is not particularly limited, and HT is preferably equal to or more than the half of HG.

Further, the width of the protruding member 46 indicated by W_{T} in FIG. 4 is not particularly limited, and is preferably equivalent to the width W_{G} of the gasket 40.

A sectional shape (the perspective of FIG. 4) of the protruding member 46 is preferably a rectangular shape. One of the long sides of the sectional shape is a surface 46a at a top portion, and the surface at the top portion is preferably a flat wide surface. In this manner, a reaction force can be obtained even with a small compression amount of the protruding member 46.

A material for configuring the protruding member 46 is not particularly limited, and can be made of the same material as the gasket.

### 1.3. Warpage of Fuel Cell

In the fuel cell 10, as described so far, between the separators forming a pair (the cathode separator 15 and the anode separator 18), the membrane electrode assembly is disposed in the power generation portion 11, and the resin sheet 23 is disposed in the outer peripheral portion 21. Further, the gasket 40 and the protruding member 46 are disposed. Here, the fuel cell 10 is hot-pressed and joined after materials for configuring the fuel cell 10 are stacked. Accordingly, the fuel cell 10 has a warped shape in which the cathode side is directed upward (convex).

### 2. Fuel Cell Unit

### 2.1. Overall Structure

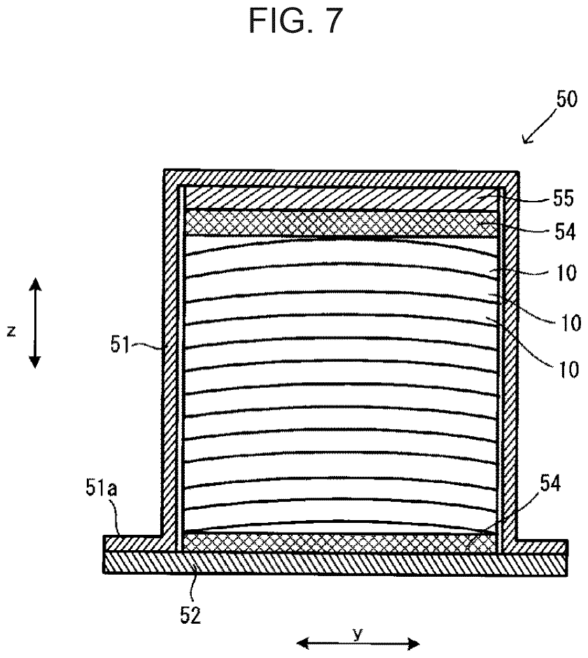

A fuel cell unit (sometimes also called a “fuel cell stack”) 50 is a member formed by stacking the fuel cells 10 (about 50 to 400 fuel cells 10) described above, and current is collected from the fuel cells 10. FIG. 7 illustrates the outline of the configuration. The fuel cell stack 50 includes a stack case 51, an end plate 52, the fuel cells 10, a current collecting plate 54, and a biasing member 55.

The stack case 51 is a casing that accommodates on its inner side the stacked fuel cells 10, the current collecting plate 54, and the biasing member 55. In the present embodiment, the stack case 51 has a rectangular tubular shape in which one end is opened and the other end is closed. In addition, a plate-shaped piece protrudes to a side opposite to the opening along the edge of the opening such that a flange 51a is formed.

The end plate 52 is a plate-shaped member, and closes the opening of the stack case 51. The end plate 52 is fixed to the stack case 51 such that a part of the stack case 51 overlapping the flange 51a caps the stack case 51 with bolts and nuts and the like.

The fuel cell 10 is as described above. The fuel cells 10 are stacked. At this time, the fuel cells 10 are disposed such that the cathode separator 15 of one fuel cell 10 overlap the anode separator 18 of the adjacent fuel cell 10. In addition, the coolant channels are formed when the grooves 15b of the cathode separator 15 overlap the grooves 18b of the anode separator 18.

The current collecting plate 54 is a member that collects current from the staked fuel cells 10. Accordingly, the current collecting plate 54 is disposed on each of one end and the other end in the stacking direction of the stack of the fuel cells 10, and one current collecting plate 54 becomes a positive electrode and the other current collecting plate 54 becomes a negative electrode. A terminal (not shown) is connected to the current collecting plate 54 such that the fuel cell 10 is configured to be electrically connectable to the outside.

The biasing member 55 is accommodated on the inner side of the stack case 51, and applies a pressing force to the stack of the fuel cells 10 in its stacking direction. Examples of the biasing member include a disc spring.

In the fuel cell unit 50 as described above, the fuel cell 10 has a warpage as described above. Thus, when such fuel cells 10 are stacked, the interval of the fuel cells 10 tends to be increased from the side on which compression is applied (the end plate side) toward the opposite side (a cell pitch tends to be increased, a gasket clearance tends to be increased). A gasket compression amount becomes insufficient particularly in a part in which the interval is increased, and the risk of gas leakage is increased. Meanwhile, when the protruding member 46 is included, the composite spring constant of the gasket and the protruding member becomes larger than the spring constant of the gasket alone. In this manner, the amount of reduction in gasket compression amount is reduced relative to the warpage reaction force of the same fuel cell, and the opening amount of the gasket clearance is reduced. Thus, the occurrence of gas leakage can be prevented.

What is claimed is:

1. A fuel cell comprising an electrode assembly between a pair of separators, the fuel cell further comprising:
a gasket disposed on a surface of one of the separators on a side opposite to a surface on a side on which the electrode assembly is disposed; and
a protruding member disposed on a surface of one of the separators on a side opposite to a surface on a side on which the electrode assembly is disposed, wherein:
the protruding member is disposed on an outer peripheral edge side of the separator from the gasket; and
a height of the protruding member is smaller than a height of the gasket.

2. The fuel cell according to claim 1, wherein the protruding member is disposed on the same surface as the surface of the one of the separators on which the gasket is disposed.

3. The fuel cell according to claim 1, wherein the protruding member is disposed on the surface of the one of the separators on the side opposite to the surface on which the gasket is disposed.

4. The fuel cell according to claim 1, wherein the protruding member is the same material as the gasket.
